(19) United States
(12) Patent Application Publication
(10) Pub. No.: US 2016/0242355 A1
(43) Pub. Date: Aug. 25, 2016

(54) Lawn Mower Blade and Blade Holder

(71) Applicant: Eugene Gordon Talaski, Bad Axe, MI (US)

(72) Inventor: Eugene Gordon Talaski, Bad Axe, MI (US)

(21) Appl. No.: 14/627,006

(22) Filed: Feb. 20, 2015

(51) Int. Cl. A01D 34/73

(52) U.S. Cl. CPC A01D 34/73

(57) ABSTRACT

A lawn maintenance device may include a cutting deck, rotating shaft with a blade holder attached to the rotating shaft. The blade holder may include grooves for attachment of the blade to the holder.

### CROSS-REFERENCE TO RELATED APPLICATIONS

Application Ser. No. 12/930,813

### STATEMENT REGARDING FEDERALLY SPONSORED RESEARCH OR DEVELOPMENT

Federally sponsored research was not used in the development of this product

### BACKGROUND OF THE INVENTION

The first lawnmower was patented in 1830 in England for cutting grass on sports grounds and extensive gardens. The first reel-type to receive a patent was in 1868 in the United States. In 1929 a power rotary lawnmower with blades that were driven horizontally was introduced. This created a very close cut. In 1938, Toro launched a power mower for the homeowner. More recently lawnmowers have been designed with riding capabilities, multiple blade decks, and more powerful gasoline engines. The cutting blades of a lawnmower are important, but the sharpness of them is often overlooked. The operator may not have the tools or desire to change the blades often to maintain a sharp cutting edge. When a blade is sharp it will do a better job of cutting the grass more evenly, leaving a nicer appearance and lessens susceptibility to diseases.

### BRIEF SUMMARY OF THE INVENTION

Some examples may provide quick-change blade systems allowing the user to make changes on a lawnmower quick and easy.

Some examples will use blades designed to be used with a corresponding blade holder that will allow an operator to change blades with little effort.

Some may require simple tools or no tools at all.

The blade change system may be used on new or retrofit existing lawnmowers.

### BRIEF DESCRIPTION OF THE SEVERAL VIEWS OF THE DRAWING

Having thus described the invention in general terms, reference will now be made to the accompanying drawings, which are not necessarily drawn to scale.

Page 1/5—complete unit of the blade holder and blade

FIG. 1A on page 1/5—curved blade

FIG. 1B on page 1/5—blade holder

FIG. 1C on page 1/5—drive coupling

Page 2/5—the blade holder

FIG. 2A on page 2/5—grooves of the blade holder

FIG. 2B on page 2/5—the locking pin

FIG. 2C on page 2/5—the center line-up bushing

FIG. 3 on page 3/5—locking mechanism cover

FIG. 4 on page 3/5—spring for locking mechanism

FIG. 5 on page 3/5—locking pin

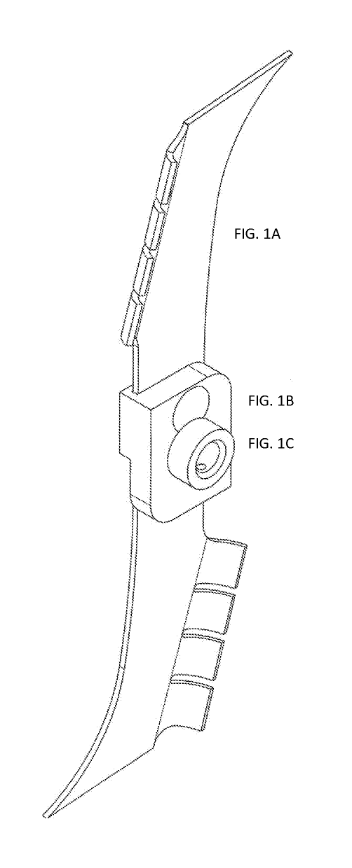

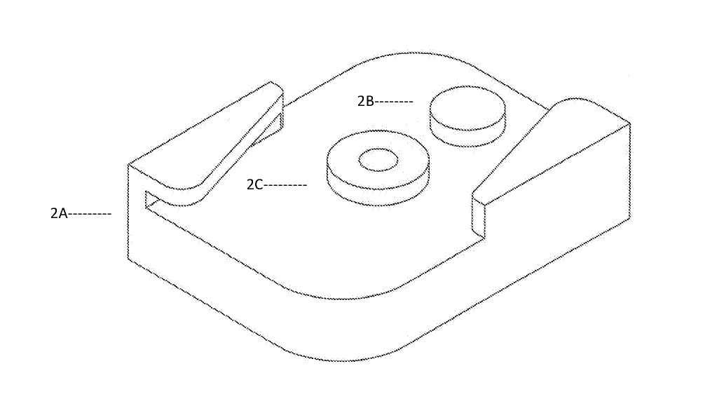

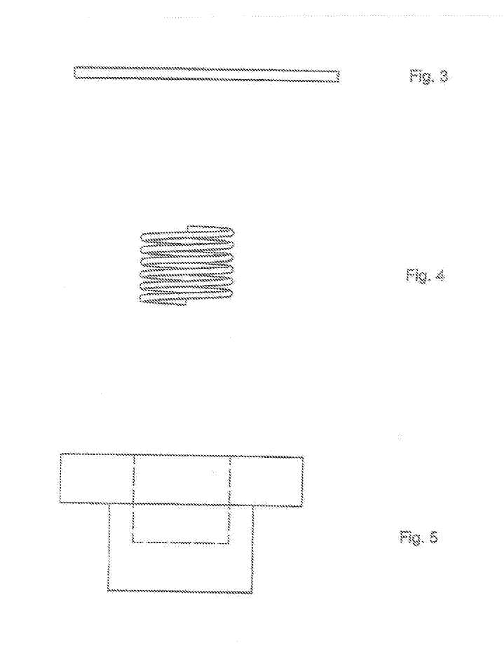

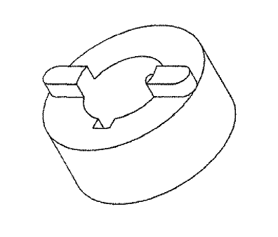

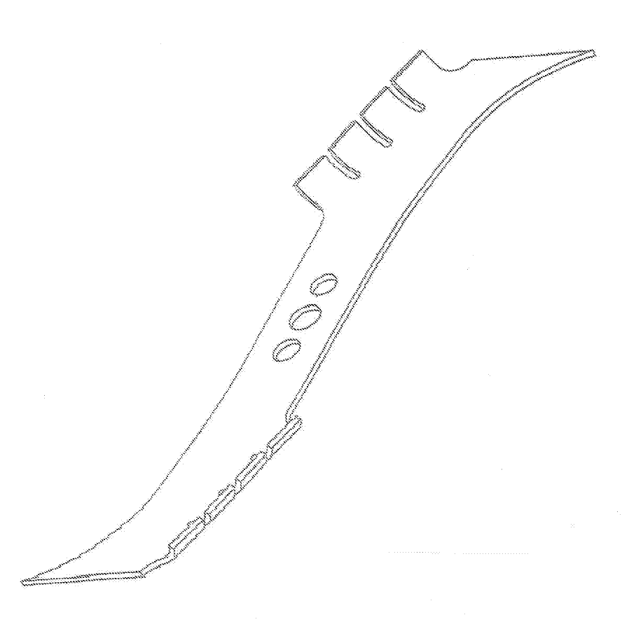

Page 4/5—the drive coupling that attaches to the rotatable shaft and blade holder

Page 5/5—the blade designed to be used with the blade holder

### DETAILED DESCRIPTION OF THE INVENTION

This invention will make changing a lawn mower blade easy and safe. There are two parts to the invention. A blade holder which is designed to accept the lawn mower blade and a lawn mower blade that is designed with a curved cutting edge. When the blade comes in contact with the grass there will be a sharp cutting action. This will cut easier and give a smoother cut. After the initial blade holder installation, the lawn mower blade can be put on or taken off of the lawn mower without any tools.

A blade holder fabricated from steel will be attached to a rotatable shaft on the lawn mower. A center bushing will allow the lawn mower blade to rotate into the grooves of the blade holder to hold the lawn mower blade on the blade holder. A locking pin will secure the lawn mower blade on to the blade holder.

To install blade to the lawn blade holder simply line up the blade to the center line up bushing twist into block holding grooves until secured by locking pin. The locking pin will snap into position.

To remove the lawn mower blade for sharpening or changing simply push in the locking pin and twist the lawn mower blade out of the blade holder grooves and the blade will eject. No tools required.

1. A blade holder with grooved channels coupled to a rotatable shaft that is designed to hold a portion of the blade.

2. The blade is designed with its special arrangement of mounting holes to work with the blade holder in claim 1.

3. The blade has a slight forward curve allowing the blade to be sharpened without losing its square cutting sharp edge, having the same sharpness as a new blade.
